(19) United States
(12) Patent Application Publication
(10) Pub. No.: US 2026/0239365 A1
(43) Pub. Date: Aug. 13, 2026

(54) SIDELINK RESOURCE SELECTION FOR AIRCRAFT COMMUNICATIONS

(71) Applicant: QUALCOMM Incorporated, San Diego, CA (US)

(72) Inventors: Vishnu Vardhan CHETLUR RAVI, San Diego, CA (US); Le LIU, San Jose, CA (US); Alberto RICO ALVARINO, San Diego, CA (US)

(21) Appl. No.: 19/536,129

(22) Filed: Feb. 10, 2026

Related U.S. Application Data
(60) Provisional application No. 63/757,082, filed on Feb. 11, 2025.

(51) Int. Cl. H04W 72/23; H04W 72/56

(52) U.S. Cl. CPC H04W 72/23; H04W 72/56

(57) ABSTRACT

Methods, systems, and devices for wireless communications are described. A wireless device may monitor at least a first set of sidelink shared channel resources in a radio frequency spectrum band associated with aircraft communications. The wireless device may select, from the first set of sidelink shared channel resources, a second set of sidelink shared channel resources for sidelink communications by the wireless device. In some examples, selection of the second set of sidelink shared channel resources is based on whether measured signal powers for the first set of sidelink shared channel resources satisfy a threshold and based on whether one or more of the measured signal powers for the first set of sidelink shared channel resources are associated with additional maximum power reductions (AMPRs). The wireless device may perform the sidelink communications via at least a portion of the second set of sidelink shared channel resources.

### CROSS REFERENCES

The present Application for Patent claims benefit of U.S. Provisional Patent Application No. 63/757,082 by CHETLUR RAVI et al., entitled “SIDELINK RESOURCE SELECTION FOR AIRCRAFT COMMUNICATIONS,” filed Feb. 11, 2025 and assigned to the assignee hereof. U.S. Provisional Patent Application No. 63/757,082 is expressly incorporated herein in its entirety.

### FIELD OF TECHNOLOGY

The following relates to wireless communications, including sidelink resource selection for aircraft communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include monitoring at least a first set of sidelink shared channel resources in a radio frequency spectrum band associated with aircraft communications, selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions, and performing the sidelink communications via at least a portion of the second set of sidelink shared channel resources.

A wireless device for wireless communications is described. The wireless device may include one or more memories storing processor executable code, and one or more processors coupled with the one or more memories. The one or more processors may individually or collectively be operable to execute the code to cause the wireless device to monitor at least a first set of sidelink shared channel resources in a radio frequency spectrum band associated with aircraft communications, select, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions, and perform the sidelink communications via at least a portion of the second set of sidelink shared channel resources.

Another wireless device for wireless communications is described. The wireless device may include means for monitoring at least a first set of sidelink shared channel resources in a radio frequency spectrum band associated with aircraft communications, means for selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions, and means for performing the sidelink communications via at least a portion of the second set of sidelink shared channel resources.

A non-transitory computer-readable medium storing code for wireless communications is described. The code may include instructions executable by one or more processors to monitor at least a first set of sidelink shared channel resources in a radio frequency spectrum band associated with aircraft communications, select, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions, and perform the sidelink communications via at least a portion of the second set of sidelink shared channel resources.

Some examples of the method, wireless devices, and non-transitory computer-readable medium described herein may further include operations, features, means, or instructions for receiving, via a sidelink control channel resource, sidelink control information from a transmitting device that indicates whether a transmission in a sidelink shared channel resource of the first set of sidelink shared channel resources may be associated with an additional maximum power reduction.

In some examples of the method, wireless devices, and non-transitory computer-readable medium described herein, the sidelink control information indicates a value for the additional maximum power reduction.

In some examples of the method, wireless devices, and non-transitory computer-readable medium described herein, the selection of one or more sidelink shared channel resources of the second set of sidelink shared channel resources may be based on the one or more sidelink shared channel resources being associated with a corresponding set of one or more smallest additional maximum power reductions.

In some examples of the method, wireless devices, and non-transitory computer-readable medium described herein, the selection of one or more sidelink shared channel resources of the second set of sidelink shared channel resources may be based on a corresponding one or more additional maximum power reductions associated with the one or more sidelink shared channel resources and a corresponding one or more reference signal strength indicator values associated with the one or more sidelink shared channel resources.

In some examples of the method, wireless devices, and non-transitory computer-readable medium described herein, the selection of one or more sidelink shared channel resources of the second set of sidelink shared channel resources may be based on a corresponding one or more additional maximum power reductions associated with the one or more sidelink shared channel resources satisfying an additional maximum power reduction threshold.

In some examples of the method, wireless devices, and non-transitory computer-readable medium described herein, the selection of one or more sidelink shared channel resources of the second set of sidelink shared channel resources may be based on applying an offset scaling factor to a corresponding one or more additional maximum power reductions associated with the one or more sidelink shared channel resources.

In some examples of the method, wireless devices, and non-transitory computer-readable medium described herein, the signal power threshold may be based on a first threshold and values of the additional maximum power reductions for sidelink shared channel resources associated with additional maximum power reduction.

In some examples of the method, wireless devices, and non-transitory computer-readable medium described herein, the signal power threshold may be based on a difference between a first threshold associated with the radio frequency spectrum band and a second threshold associated with the first set of sidelink shared channel resources.

In some examples of the method, wireless devices, and non-transitory computer-readable medium described herein, the signal power threshold may be based on the additional maximum power reductions based on the additional maximum power reductions satisfying additional maximum power reductions thresholds.

In some examples of the method, wireless devices, and non-transitory computer-readable medium described herein, the signal power threshold may be based on an offset scaling factor to the additional maximum power reductions.

In some examples of the method, wireless devices, and non-transitory computer-readable medium described herein, a threshold quantity of sidelink shared channel resources included in the second set of sidelink shared channel resources may be based on a type of the wireless device, configuration information for additional maximum power reduction, a service type of the sidelink communications, a traffic type of the sidelink communications, the radio frequency spectrum band, or any combination thereof.

Some examples of the method, wireless devices, and non-transitory computer-readable medium described herein may further include operations, features, means, or instructions for receiving configuration information that indicates a threshold quantity of sidelink shared channel resources in the second set of sidelink shared channel resources.

Some examples of the method, wireless devices, and non-transitory computer-readable medium described herein may further include operations, features, means, or instructions for reporting the second set of sidelink shared channel resources to a higher layer of the wireless device based on selecting the second set of sidelink shared channel resources.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports sidelink resource selection for aircraft communications in accordance with one or more aspects of the present disclosure.

FIG. 2 shows an example of a wireless communications system that supports sidelink resource selection for aircraft communications in accordance with one or more aspects of the present disclosure.

FIG. 3 shows an example of a process flow that supports sidelink resource selection for aircraft communications in accordance with one or more aspects of the present disclosure.

FIGS. 4 and 5 show block diagrams of devices that support sidelink resource selection for aircraft communications in accordance with one or more aspects of the present disclosure.

FIG. 6 shows a block diagram of a communications manager that supports sidelink resource selection for aircraft communications in accordance with one or more aspects of the present disclosure.

FIG. 7 shows a diagram of a system including a device that supports sidelink resource selection for aircraft communications in accordance with one or more aspects of the present disclosure.

FIGS. 8 through 10 show flowcharts illustrating methods that support sidelink resource selection for aircraft communications in accordance with one or more aspects of the present disclosure.

### DETAILED DESCRIPTION

In some wireless communications systems, radio frequency spectrum band of a radio frequency spectrum may be allocated for communications between different types of devices. For example, a radio frequency spectrum band may be allocated for sidelink communications between aircraft, such as unmanned aerial vehicles (UAVs) or other types of aerial wireless devices. In some examples, a wireless device may apply an additional maximum power reduction (AMPR) to a transmit power when communicating on the radio frequency spectrum band. For example, current regulations may enforce aircraft to apply an AMPR when the aircraft is in proximity to a ground radio system (GRS). A value for the AMPR (e.g., how much a wireless device reduces transmission power) may vary based on a frequency of a resource within the radio frequency spectrum band (e.g., being in a lower, higher, or middle edge of the band), a configuration of the radio frequency spectrum band (e.g., a size of a guard band between other radio frequency spectrum bands), or a distance of the wireless device (e.g., aircraft) from one or more GRSs, or any combination thereof.

In some cases, resources for sidelink communications, such as semi-persistently scheduled sidelink communications, may be scheduled or reserved based on performing channel sensing on resources. If a power measurement for a sidelink shared channel resource satisfies a threshold, the sidelink shared channel resource may be included in a set of candidate resources for sidelink communications. Resources in the set of candidate resources with smallest reference signal strength indicator (RSSI) measurements may be included in a set of resources that are available for sidelink communications. For sidelink communications on a radio frequency spectrum band where wireless devices may apply AMPR when transmitting, a first wireless device may perform a sensing procedure to obtain a power measurement for a sidelink shared channel resource, and a comparison of the power measurement to a threshold may indicate the sidelink shared channel resource is an available candidate resource. However, a second wireless device may be transmitting via the sidelink shared channel resource and applying an AMPR to reduce transmit power, which may correspond to a low power measurement for the sidelink shared channel resource. If the first wireless device selects the sidelink shared channel resource to communicate its own sidelink shared channel signaling, sidelink communications from the first wireless device and the second wireless device may collide and result in interference. Therefore, AMPR application for sidelink communications with current techniques may not be reliable.

Techniques described herein support sidelink channel sensing based on AMPR. For example, sidelink control information (SCI) that indicates (e.g., reserves) a sidelink shared channel resource for a sidelink shared channel transmission may indicate whether AMPR is applied for the sidelink shared channel transmission. In some examples, the SCI may indicate a value for the AMPR, or the SCI may indicate location information for the transmitting device, which may be used by other wireless devices to determine whether AMPR is applied or not. In some examples, a wireless device performing sensing may determine available resources from candidate sidelink shared channel resource based on whether AMPR is applied. For example, the wireless device may select resources which are associated with a smallest AMPR from the set of candidate resources. In some examples, the wireless device may select available resources based on RSSI measurements of candidate resources and applied AMPR associated with the candidate resources. In some examples, a threshold for determining whether a resource is to be included in the set of candidate resources may be based on AMPR, such as by offsetting the RSSI threshold by an AMPR associated with the resource or by an amount based on such an AMPR (e.g., negating transmit power reductions applied for the resource). In some examples, a quantity of resources that are selected as available for sidelink communications from the set of candidate resources may be configurable, for example based on a type of wireless device operating on the radio frequency spectrum band, AMPR configurations, service or traffic types of the sidelink communications, or be band-specific. In some examples, the quantity of resources to be selected as available may be configured, for example by a network entity.

Aspects of the disclosure are initially described in the context of wireless communications systems. Aspects of the disclosure are further illustrated by and described with reference to a process flow, apparatus diagrams, system diagrams, and flowcharts that relate to sidelink resource selection for aircraft communications.

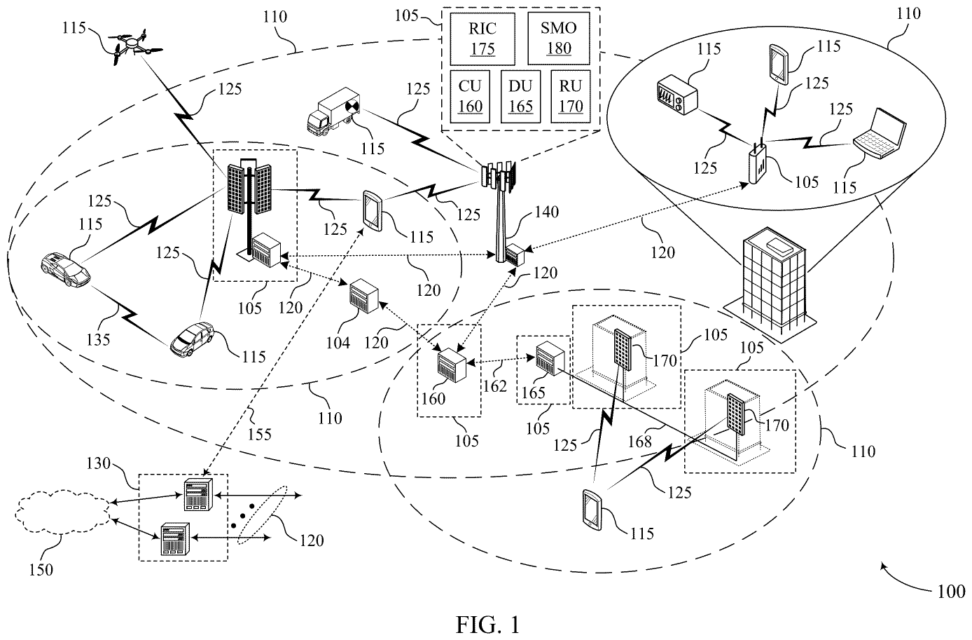

FIG. 1 shows an example of a wireless communications system 100 that supports sidelink resource selection for aircraft communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support sidelink resource selection for aircraft communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may include radio frequency spectrum bands which are configured for specific types of devices or specific types of signaling. For example, a radio frequency spectrum may include a radio frequency spectrum band with an allocation for networked communications for aerial devices, such as high flying drones, UAVs, aircraft, and the like. In some examples, a portion of the radio frequency spectrum band may be used for D2D or sidelink communications.

In some examples, communications using the radio frequency spectrum band allocated for sidelink communications of aerial devices may comply with some restrictions or requirements. For example, the communications may comply with Radio Technical Commission for Aeronautics (RTCA) requirements. In some examples, a wireless device communicating on the radio frequency spectrum band may be required to transmit at a lower power level. For example, if the wireless device is in proximity to a GRS, the wireless device may apply an AMPR to reduce transmit power.

In some examples, wireless device may apply AMPR while transmitting in at least a subset of the radio frequency spectrum band. For example, if a 20 MHz radio frequency spectrum band is allocated for sidelink communications, a wireless device may apply an AMPR while transmitting in a portion of the 20 MHz radio frequency spectrum band (e.g., if conditions for applying the AMPR are satisfied). In some examples, the portion of the radio frequency spectrum band associated with AMPR may be based on a size of the radio frequency spectrum band (e.g., a length of contiguous resource blocks for the radio frequency spectrum band) or a starting resource block of the radio frequency spectrum band (e.g., a frequency of the starting resource block), or both. In some examples, if locations of potential victim devices (e.g., GRSs) are known, a wireless device may apply AMPR in regions that are close to the potential victim devices. For example, a wireless device may apply AMPR when the wireless device is in proximity of a GRSs, such as when the wireless device is near an airport.

AMPR for sidelink communications may be based on a location of a radio frequency spectrum band allocated for sidelink communications in a channel. For example, if 60 MHz are allocated for aerial device communications, and 20 MHz of the 60 MHz are allocated for aerial device sidelink communications, AMPR may be based on where the 20 MHz band is within the 60 MHz (e.g., a lower band or lowest 20 MHz, a middle band, or a higher band or highest 20 MHz). In some examples, AMPR may be based on a size of a guard band between the sidelink radio frequency spectrum band and other radio frequency spectrum bands (e.g., RTCA bands). In some examples, AMPR values may be based on a starting resource block index (e.g., for a resource allocation associated with sidelink communications) and a quantity of resource blocks in the allocation.

In some examples, semi-persistent scheduling (SPS) may be used for sidelink communications. In some examples, sidelink SPS communications may be implemented for sidelink transmission mode 3 or sidelink transmission mode 4, or both, in an LTE system and sidelink transmission mode 1 or sidelink transmission mode 2 in an NR system. A wireless device, such as a UE 115, a UAV, or an aerial device, may determine a subset of resources to be reported to higher layers in physical sidelink shared channel (PSSCH) resource selection, for example for sidelink transmission mode 3 or sidelink transmission mode 4, or both, (e.g., in an LTE system) and sidelink transmission mode 1 or sidelink transmission mode 2, or both (e.g., in an NR system).

A wireless device performing sensing for sidelink communications (e.g., SPS sidelink communications) may monitor subframes in a radio frequency spectrum band, excluding subframes in which the wireless device transmits. In some examples, the wireless device may monitor M subframes, from n-1000 to n-1, except for subframes in which the wireless device is transmitting. For example, the wireless device may monitor all subframes in the radio frequency spectrum band in which the wireless device is operating.

The wireless device may determine a set of candidate resources based on the monitoring. A first set of resources, set S_{A}, may correspond to a union of all candidate single subframe resources. A second set of resources, set S_{B}, may be initialized to an empty set. The wireless device may exclude any candidate single-subframe resource (e.g., from set S_{A}) if the candidate single-subframe satisfies one or more conditions. If the wireless device receives SCI (e.g., SCI format 1) in subframe m indicating a resource reservation period P_{rsvp_Rx} and a priority prio_{Rx}, a PDSCH RSRP measurement according to the received SCI is higher than a threshold (e.g., Th_{prioTx, prioRx}), and/or a set of resources at subframe m would overlap with a future transmission in a resource, the resource may be excluded from the first set of resources S_{A}. If a quantity of candidate single-subframe resources remaining in the set S_{A} is smaller than a threshold (e.g., 0.2*Mₜₒₜₐₗ, where Mₜₒₜₐₗ is a total quantity of single-subframe resources), the wireless device may repeat the process with a higher threshold (e.g., a threshold increased by 3 dB), which may increase the quantity of resources with RSRP measurements which satisfy the threshold (e.g., have RSRP measurements below the RSRP threshold).

The wireless device may select resources from set S_{A} for set S_{B}. The wireless device may report the set S_{B} to higher layers, and a portion of resources from set SB may be selected for sidelink communications (e.g., SPS sidelink communications). For example, resources selected for (e.g., moved to) set S_{B} may correspond to candidate resources with a low likelihood of collision. In some examples, the wireless device may move candidate single-subframe resource R_{x, y} with a smallest metric (e.g., metric E_{x, y}) from set S_{A} to set S_{B}. The metric E_{x, y} may correspond to (e.g., be based on) a linear average of RSSI measured in subchannels x to x+L_{subCH}−1, where L_{subCH} is a quantity of subchannels to be used for the transmission in the radio frequency spectrum band. The wireless device may repeat the process (e.g., moving candidate resources from set S_{A} to S_{B}) until a quantity of candidate single-subframe resources in set S_{B} is greater than or equal to a threshold quantity (e.g., 0.2*Mₜₒₜₐₗ).

For sidelink communications on a radio frequency spectrum band where wireless devices may apply AMPR when transmitting, a first wireless device may perform a sensing procedure to obtain a power measurement for a sidelink shared channel resource, and a comparison of the power measurement to a threshold may indicate the sidelink shared channel resource is an available candidate resource. However, a second wireless device may be transmitting via the sidelink shared channel resource and applying an AMPR to reduce transmit power, which may correspond to a low power measurement (e.g., RSRP measurement, RSSI measurement, or both) for the sidelink shared channel resource. If the first wireless device selects the sidelink shared channel resource to communicate its own sidelink shared channel signaling, sidelink communications from the first wireless device and the second wireless device may collide and result in interference. In some examples, application of an AMPR may be associated with a bias in resource selection such that wireless devices may be more likely to select sidelink shared channel resources that are associated with a higher AMPR, leading to increased likelihood of collision. Therefore, AMPR application for sidelink communications in some systems may be less reliable than preferred.

The wireless communications system 100 may support techniques for channel sensing based on AMPR. For example, SCI that schedules (e.g., reserves) a sidelink shared channel resource for a sidelink shared channel transmission may indicate whether AMPR is applied for the sidelink shared channel transmission. In some examples, the SCI may indicate a value for the AMPR, or the SCI may indicate location information for the transmitting device, which may be used by other wireless devices to determine whether AMPR is applied or not.

In some examples, a wireless device performing sensing may determine to include a sidelink shared channel resource in set S_{B} based on whether AMPR is applied for the sidelink shared channel resource. For example, the wireless device may select resources for set S_{B} from set S_{A} which are associated with a smallest AMPR from the set of candidate resources. In some examples, the wireless device may select resources for set S_{B} based on RSSI measurements of candidate resources and applied AMPR associated with the candidate resources. In some examples, a threshold for determining whether a resource is to be included in the set of candidate resources (e.g., set S_{A}) may be based on AMPR, such as by being offset by an AMPR associated with the resource (e.g., negating transmit power reductions applied for the resource). In some examples, the wireless device may select resources for set S_{B} based on AMPR and also determine if a resource is to be included in the set of candidate resources (e.g., for set S_{A}) based on AMPR. In some examples, a quantity of resources to be selected for set S_{B} may be configurable, for example based on a type of wireless device operating on the radio frequency spectrum band, AMPR configurations, service or traffic types of the sidelink communications, or be band-specific. In some examples, the quantity of resources to be selected for set S_{B} may be configured, for example by a network entity 105.

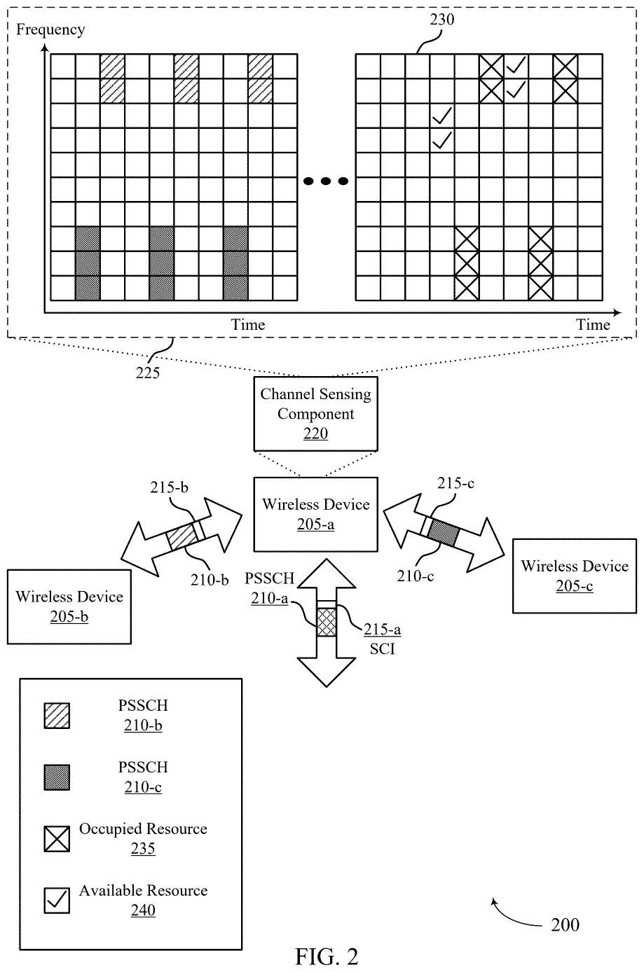

FIG. 2 shows an example of a wireless communications system 200 that supports sidelink resource selection for aircraft communications in accordance with one or more aspects of the present disclosure. The wireless communications system 200 may include aspects of a wireless communications system 100. For example, the wireless communications system 200 may include a wireless device 205-a, a wireless device 205-b, or a wireless device 205-c, or any combination thereof. In some examples, a wireless device 205 may be an example of a UE 115 as described with reference to FIG. 1. For example, the wireless device 205 may be an example of a UAV, an aircraft, an aerial device, or any combination thereof.

The wireless communications system 200 may support sidelink communications. For example, a wireless device 205 may transmit a PSSCH transmission 210 using resources of a radio frequency spectrum band. The wireless device 205 may transmit SCI 215 indicating information (e.g., reservation information, scheduling information, priority information, or any combination thereof) for the PSSCH transmission 210. In some examples, the SCI 215 may be an example of first-stage SCI. In some examples, the SCI 215 may be broadcast. In some examples, the radio frequency spectrum band may be configured for sidelink communications between aerial devices (e.g., aircraft), such as the wireless devices 205.

In some examples, the wireless device 205-a may perform a channel sensing procedure to select resources for sidelink communications, such as SPS sidelink communications. A channel sensing component 220 of the wireless device 205-a may monitor subframes in a sensing window 225 for signaling. In some examples, the wireless device 205 may monitor all subframes in the sensing window 225 except for subframes during which the wireless device 205 is transmitting. For example, for transmission starting from subframe 230 (e.g., subframe n), the wireless device 205-a may monitor subframes n-1000 to n-1, except for those in which the wireless device 205-a is transmitting.

For SPS sidelink communications, channel sensing may be implemented to determine whether future resources will be used for a PSSCH transmission 210 based on a periodicity of the PSSCH transmission 210. For example, if the wireless device 205-a detects a high power measurement for a resource, this may correspond to the resource being used by another wireless device 205 for a PSSCH transmission. The wireless device 205-a may determine whether a future resource, in some examples based on periodicity information associated with a PSSCH transmission 210, will be occupied or unoccupied (e.g., available) based on the channel sensing.

The wireless device 205-a may determine a first set of resources including candidate resources based on the sensing. For example, the first set of resources may be an example of set S_{A} described herein, including candidate single subframe resources. The wireless device 205-a may exclude resources from the first set of resources if the resources satisfy one or more conditions. For example, for a resource, if the wireless device 205-a receives an SCI 215 in subframe m indicating resource reservation information (e.g., resource reservation period P_{RSVP_Rx}) and priority information (e.g., prio_{Rx}), and a PSSCH RSRP measurement according to the SCI 215 is higher than a threshold (e.g., Th_{prioTx}, prio_{Rx}), and the set of resources at subframe m would overlap with a future transmission in the resource, the wireless device 205-a may not include the resource in the first set of resources. In some examples, if one or more of the conditions are not satisfied, the wireless device 205-a may include the resource in the first set of resources.

The wireless device 205-a may move candidate resources from the first set of resources to a second set of resources based on metrics of the resources. For example, the wireless device may move a candidate single-subframe resource R_{x, y} with a smallest metric E_{x, y} from set S_{A} to set S_{B}. The metric Ex_{, y} may be based on a linear average of sidelink RSSI measured in subchannels x through x+L_{subCH}−1 of a resource. The second set of resources may be reported to higher layers, and the wireless device 205-a may select one or more resources from the second set of resources to perform sidelink communications (e.g., sidelink transmission).

In some examples, a wireless device 205 may apply AMPR when transmitting a PSSCH transmission 210. For example, the wireless device 205-b may apply AMPR when transmitting a PSSCH transmission 210-b. In some examples, the wireless device 205-b may apply the AMPR based on location information of the wireless device 205-b. For example, the wireless device 205-b may be in proximity to a GRS. Additionally, or alternatively, the wireless device 205-b may apply the AMPR based on selected resources for the PSSCH transmission 210-b.

While performing channel sensing, the wireless device 205-a may measure the resources used by the wireless device 205-b to transmit the PSSCH transmission 210-b. Based on application of the AMPR by the wireless device 205-b, a power measurement of the resources used for the PSSCH transmission 210-b may be relatively low. For example, the AMPR may have lowered the transmission power of the PSSCH transmission 210-b such that the power measurement of the resources satisfies a threshold for channel sensing. In some examples, the wireless device 205-a may include the resources used to transmit the PSSCH transmission 210-b in the first set of resources (e.g., set S_{A}). However, selection of these resources to the second set of resources (e.g., set S_{B}) may result in collision.

The wireless device 205-a may measure resources used by the wireless device 205-c to transmit a PSSCH transmission 210-c. The wireless device 205-c may not apply AMPR to transmit the PSSCH transmission 210-c. For example, the wireless device 205-c may not be in proximity to a GRS, or the wireless device 205-c may not be required to apply AMPR for a portion of the radio frequency spectrum band used to transmit the PSSCH transmission 210-c. Thus, a power measurement for the resources used to transmit the PSSCH transmission 210-c may be above the threshold, and the resources used to transmit the PSSCH transmission 210-c may not be included in the first set of resources.

The wireless communications system 200 supports techniques for channel sensing based on AMPR. In some examples, a transmitting device (e.g., the wireless device 205-b or the wireless device 205-c, or both) may transmit an indication of whether AMPR is being applied. For example, SCI 215 may include an indication of AMPR. In some examples, the SCI 215 may include an indication (e.g., an explicit indication) of an AMPR value applied for a PSSCH transmission 210. For example, the AMPR value applied for the PSSCH transmission 210 may be determined based on decoding the SCI 215. In some examples, the AMPR value may be implicitly indicated by a location of the transmitting device. For example, the SCI 215 may include information or location information of the transmitting device, and restriction areas (e.g., areas where AMPR is to be applied) may be defined or configured. In some examples, implicit indication of AMPR may be based on zone identification, for example based on a configuration or definition of zones where AMPR is to be applied.

AMPR may be implemented by some, but not all, transmitting devices. For example, the wireless device 205-b may apply AMPR, and the wireless device 205-c may not apply AMPR. The wireless device 205-a may implement techniques for resource selection and channel sensing based on the indication of AMPR, for example the indication of AMPR via SCI 215. Based on the indication of AMPR, the wireless device 205-a may apply AMPR-based adjustments for resource selection for wireless devices which are applying AMPR (e.g., when evaluating resources used by the wireless device 205-b to transmit the PSSCH transmission 210-b) and not for wireless devices which are not applying AMPR (e.g., when evaluating resources used by the wireless device 205-c to transmit the PSSCH transmission 210-c). The indication of AMPR may distinguish a nearby transmitting device using a lower transmit power (e.g., based on AMPR application) from a farther transmitting device transmitting at maximum power, although the signals from the two transmitting devices may be received at similar power levels.

In some examples, a wireless device 205, such as the wireless device 205-a, may select resources for the second set of resources based on AMPR. For example, the wireless device 205-a may perform AMPR-based ranking of resources from the first set of resources (e.g., set S_{A}) when determining resources to include in the second set of resources (e.g., set S_{B}). In some examples, the wireless device 205-a may select resources with a smallest AMPR applied, and move those resources from set S_{A} to set S_{B} (e.g., in the SPS resource selection process).

In some examples, the wireless device 205-a may select resources for the second set of resources which have a smallest metric that is based on RSSI and AMPR. For example, the wireless device 205-a may evaluate resources in the first set of resources based on a metric which may be based on (e.g., derived as a function of) both a measured linear average RSSI (e.g., E_{x, y}) and an AMPR applied to the transmission in those subchannels (e.g., AMPR_{X, Y}). For example, the metric may be based on a sum of E_{x, y} and AMPR_{X, Y}. Resources in the first set of resources with the smallest metric based on RSSI and AMPR may be moved from the first set of resources to the second set of resources.

In some examples, the wireless device 205-a may perform AMPR-based ranking (e.g., AMPR-based selection to the second set of resources) based on an AMPR satisfying a threshold. For example, if an AMPR for a resource is above a threshold, the wireless device 205-a may evaluate selection of the resource to the second set of resources based on AMPR. If an AMPR for a resource is below the threshold, the wireless device 205-a may evaluate the selection of the resource to the second set of resources based on other factors (e.g., E_{x, y} without considering AMPR). In some examples, an AMPR-based ranking scheme (e.g., AMPR-based selection to the second set of resources) may be based on an offset scaling factor. For example, the wireless device 205-a may apply an offset scaling factor to measurements performing on resources associated with AMPR. The offset scaling factor may be configurable or may be statically configured (e.g., preconfigured) at the wireless device 205-a.

In some examples, a threshold associated selecting resources for the first set of resources may be based on AMPR. For example, an RSRP threshold used to determine whether a resource is to be included in the first set of resources (e.g., set S_{A}) may be offset based on AMPR. In some examples, offsetting the RSRP threshold based on an AMPR value may negate the reduced transmit power applied by AMPR when determining whether a resource is to be included in the first set of resources. Applying the offset to the threshold may be used with one or more techniques used to select resources for the second set of resources (e.g., set S_{B}) from the first set of resources described herein.

In some examples, a supported maximum transmit power for a transmitting device may be a relatively low value. For example, AMPR may not be applied in some scenarios, as a supported or enabled maximum transmit power may be low, for example such that transmissions at the maximum transmit power may not affect GRSs. In some examples, an offset for the RSRP threshold may be based on a difference between a maximum transmit power allowed across all RBs and a maximum power allowed for RBs of interest. For example, when evaluating whether to include a resource in the first set of resources, the RSRP threshold may be offset by a value that is determined based on a difference between a first maximum transmit power (e.g., allowed across all resource blocks of a radio frequency spectrum band) and a second transmit power (e.g., allowed for the evaluated resource. Additionally, or alternatively, the RSRP threshold may be offset based on an offset scaling factor, such as the offset scaling factor used for selection of resources from the first set of resources to the second set of resources.

In some examples, the wireless device 205-a may include a certain quantity or percentage of resources (e.g., of the total resources) in the second set of resources. For example, the wireless device 205-a may perform a resource selection process to select resources for the second set of resources (e.g., set S_{B}) to select a top 20 percent of total resources (e.g., of total resources in the radio frequency spectrum band). In some examples, the quantity of resources or the percent of total resources may be configurable. For example, the wireless device 205-a may select different percents of the total resources for the second set of resources based on types of wireless devices operating on the radio frequency spectrum band, AMPR configurations, service types of signaling communicated on the radio frequency spectrum band, traffic types of signaling communicated on the radio frequency spectrum band, or any combination thereof. In some examples, the percent of resources to select may be band-specific. In some examples, a wireless device 205 may be configured with a parameter (e.g., ResourceSelectionFraction) that indicates a fraction or percentage of total candidate resources that are to be selected to the second set of resources. In some examples, the parameter may be pre-configured at the wireless device, configured by the network (e.g., via a network entity 105), obtained from higher layers (e.g., received with priority and reservation period information), or determined based on observed channel occupancy levels (e.g., using a channel busy rate), or any combination thereof.

The wireless device 205-a may perform channel sensing and resource selection according to the techniques described herein. For example, the wireless device 205-a may receive SCI 215-b from the wireless device 205-b and determine the PSSCH transmission 210-b is transmitted according to AMPR. During resource selection, the wireless device 205-a may determine whether to select resources associated with transmission of the PSSCH transmission 210-b for the first set of resources (e.g., S_{A}) or the second set of resources (e.g., S_{B}), or both, based on the AMPR applied for the PSSCH transmission 210-b. For example, based on performing resource selection based on AMPR, the wireless device 205-a may determine that resources corresponding to the resources used for the PSSCH transmission 210-b are occupied resources 235.

The wireless device 205-a may receive SCI 215-c from the wireless device 205-c and determine the PSSCH transmission 210-c is not transmitted according to AMPR. During resource selection, the wireless device 205-a may determine whether to select resources associated with transmission of the PSSCH transmission 210-c for the first set of resources or the second set of resources, or both, based on AMPR not being applied for the PSSCH transmission 210-c. For example, based on performing resource selection, the wireless device 205-a may determine that resources corresponding to the resources used for the PSSCH transmission 210-c are occupied resources 235.

The wireless device 205-a may send the second set of resources to higher layers. For example, the second set of resources may include available resources 240, or resources which the wireless device 205-a determines to be available based on the channel sensing procedure and during resource selection. The wireless device may transmit SCI 215-a indicating resource reservation information, transmission priority information, and AMPR information for the PSSCH transmission 210-a. The wireless device may transmit the PSSCH transmission 210-a via resources of the second set of resources (e.g., at least a portion of the second set of resources).

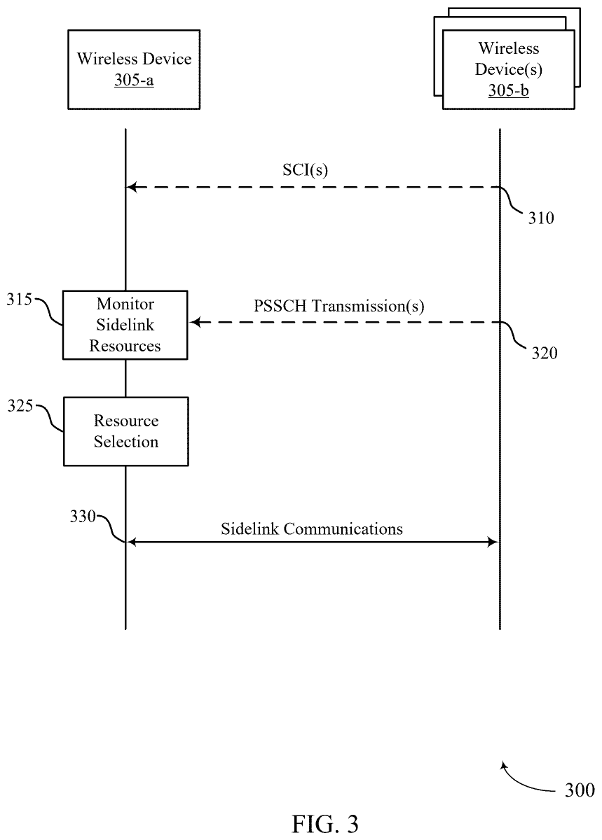

FIG. 3 shows an example of a process flow 300 that supports sidelink resource selection for aircraft communications in accordance with one or more aspects of the present disclosure. The process flow 300 may include aspects of a wireless communications system 100 or a wireless communications system 200 described herein. For example, the process flow 300 may be implemented by a wireless device 305-a, which may be an example of a wireless device 205 as described with reference to FIG. 2 or a UE 115 as described herein, or both. The process flow 300 may include one or more additional wireless devices 305-b, each of which may be an example of a wireless device 205 or a UE 115 as described herein.

Alternative examples of the following may be implemented, where some steps are performed in a different order than described or are not performed at all. In some cases, steps may include additional features not mentioned below, or further steps may be added. Although the wireless devices 305 are shown performing the operations of the process flow 300, some aspects of some operations may also be performed by one or more other wireless devices.

In some examples, at 310, the wireless device 305-a may receive sidelink control information. For example, the wireless device 305-a may receive, via a sidelink control channel resource, SCI from a transmitting device, such as a wireless device 305-b, that indicates whether a transmission in the sidelink shared channel resource is associated with AMPR. In some examples, the SCI may indicate a value for the AMPR. In some examples, the SCI may indicate location information of the transmitting device, and the wireless device 305-a may determine an AMPR associated with the location information of the transmitting device.

At 315, the wireless device 305-a may monitor at least a first set of sidelink shared channel resources in a radio frequency spectrum band associated with aircraft communications. For example, the wireless device 305-a may monitor each resource (e.g., each resource the wireless device 305-a is transmitting during). The wireless device 305-a may select the first set of resources from the total resources based on the first set of resources satisfying a threshold.

In some examples, the wireless device 305-a may receive one or more PSSCH transmission(s) from the one or more wireless device(s) 305-b, for example during the monitoring. For example, the one or more wireless device(s) 305-b may transmit the one or more PSSCH transmission(s) at 320. In some examples, the wireless device 305-a may not be an intended recipient of the one or more PSSCH transmission(s). The wireless device 305-a may obtain an RSRP measurement or an RSSI measurement, or both, of sidelink shared channel resources used to transmit the one or more PSSCH transmission(s) based on the monitoring. In some examples, the wireless device 305-a may select the first set of sidelink shared channel resources based on RSRP measurements of all of the sidelink shared channel resources of the radio frequency spectrum band, including sidelink shared channel resources used to transmit the one or more PSSCH transmission(s).

At 325 the wireless device 305-a may select a second set of sidelink shared channel resources for sidelink communications. For example, the wireless device 305-a may select, from the first set of sidelink shared channel resources, a second set of sidelink shared channel resources for sidelink communications by the wireless device 305-a. In some examples, selection of the second set of sidelink shared channel resources may be based on whether measured signal powers for the first set of sidelink shared channel resources satisfy a signal power threshold. Selection of the second set of sidelink shared channel resources may be further based on whether one or more of the measured signal powers for the first set of sidelink shared channel resources are associated with AMPR.

For example, the wireless device 305-a may receive SCI indicating that a PSSCH transmission is transmitted using AMPR, and resources used for the PSSCH transmission may be associated with AMPR. If the resources satisfy conditions to be included in the first set of resources (e.g., set S_{A} as described herein), the wireless device 305-a may determine whether to include the resources in a second set of resources (e.g., set S_{B} as described herein) based on the resources being associated with AMPR.

In some examples, the selection of one or more sidelink shared channel resources of the second set of sidelink shared channel resources may be based on the one or more sidelink shared channel resources being associated with a corresponding set of one or more smallest additional maximum power reductions. For example, the wireless device 305-a may select resources associated with the smallest AMPR values for the second set of resources. In some examples, the selection of one or more sidelink shared channel resources of the second set of sidelink shared channel resources may be based on a corresponding one or more AMPRs associated with the one or more sidelink shared channel resources and a corresponding one or more RSSI values (e.g., RSSI measurements) associated with the one or more sidelink shared channel resources. For example, the wireless device 305-a may determine whether to include a resource in the second set of resources based on a metric that is determined based on both an AMPR value associated with (e.g., indicated for) the resource and an RSSI measurement of the resource.

In some examples, the selection of one or more sidelink shared channel resources of the second set of sidelink shared channel resources may be based on a corresponding one or more AMPRs associated with the one or more sidelink shared channel resources satisfying an AMPR threshold. For example, the wireless device 305-a may perform AMPR-based ranking (e.g., selection to the second set of resources) if an AMPR satisfies the AMPR threshold. For resources with AMPRs that do not satisfy the threshold (e.g., small AMPR values), the wireless device 305-a may not use AMPR-based ranking to determine whether to include the resources in the second set of resources. In some examples, the selection of one or more sidelink shared channel resources of the second set of sidelink shared channel resources is based on applying an offset scaling factor to a corresponding one or more AMPRS associated with the one or more sidelink shared channel resources.

In some examples, the wireless device 305-a may use a threshold that is based on AMPR for selecting resources to the first set of resources (e.g., set S_{A}). For example, the signal power threshold may be based on a first threshold and values of AMPRs for the sidelink shared channel resources with AMPRs. For example, the RSRP threshold for a resource may be offset by an AMPR value associated with the resource. In some examples, the signal power threshold is based on a difference between a first threshold associated with the radio frequency spectrum band and a second threshold associated with the first set of sidelink shared channel resources.

At 330, the wireless device 305-a may perform the sidelink communications via at least a portion of the second set of sidelink shared channel resources. For example, the wireless device 305-a may select the portion of the second set of shared channel resources for the sidelink communications, and the wireless device 305-a may transmit SCI, a PSSCH transmission, or both, via the portion of the second set of shared channel resources.

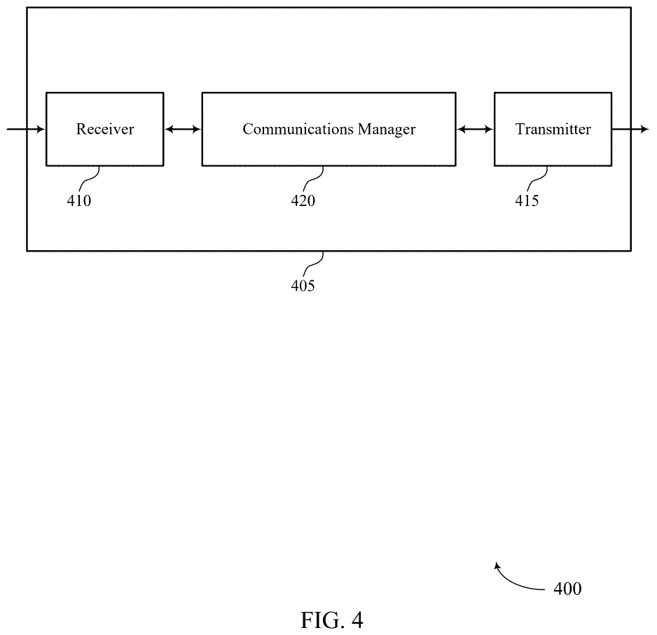

FIG. 4 shows a block diagram 400 of a device 405 that supports sidelink resource selection for aircraft communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to sidelink resource selection for aircraft communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to sidelink resource selection for aircraft communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of sidelink resource selection for aircraft communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for monitoring at least a first set of sidelink shared channel resources in a radio frequency spectrum band associated with aircraft communications. The communications manager 420 is capable of, configured to, or operable to support a means for selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The communications manager 420 is capable of, configured to, or operable to support a means for performing the sidelink communications via at least a portion of the second set of sidelink shared channel resources.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and, reduced power consumption, and more efficient utilization of communication resources.

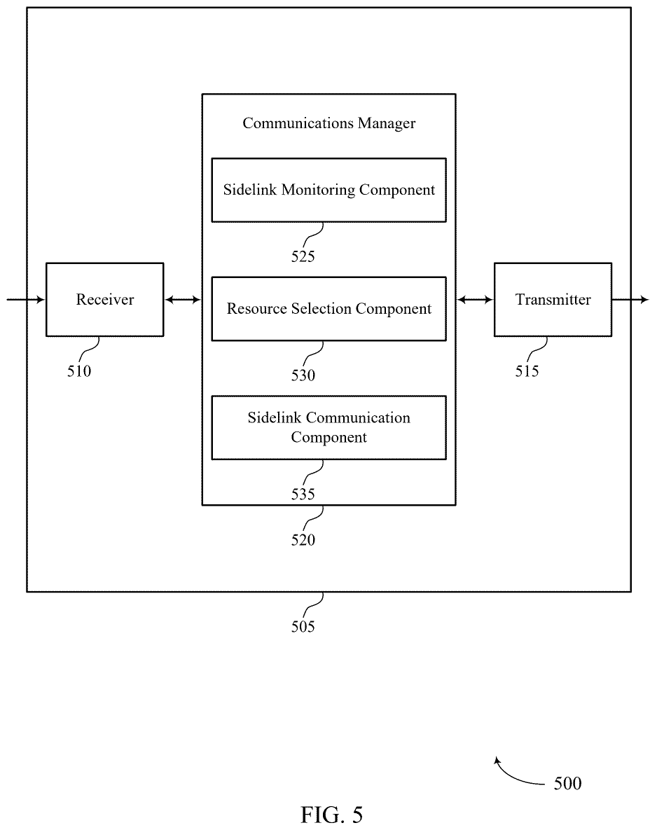

FIG. 5 shows a block diagram 500 of a device 505 that supports sidelink resource selection for aircraft communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink resource selection for aircraft communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink resource selection for aircraft communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of sidelink resource selection for aircraft communications as described herein. For example, the communications manager 520 may include a sidelink monitoring component 525, a resource selection component 530, a sidelink communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The sidelink monitoring component 525 is capable of, configured to, or operable to support a means for monitoring at least a first set of sidelink shared channel resources in a radio frequency spectrum band associated with aircraft communications. The resource selection component 530 is capable of, configured to, or operable to support a means for selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The sidelink communication component 535 is capable of, configured to, or operable to support a means for performing the sidelink communications via at least a portion of the second set of sidelink shared channel resources.

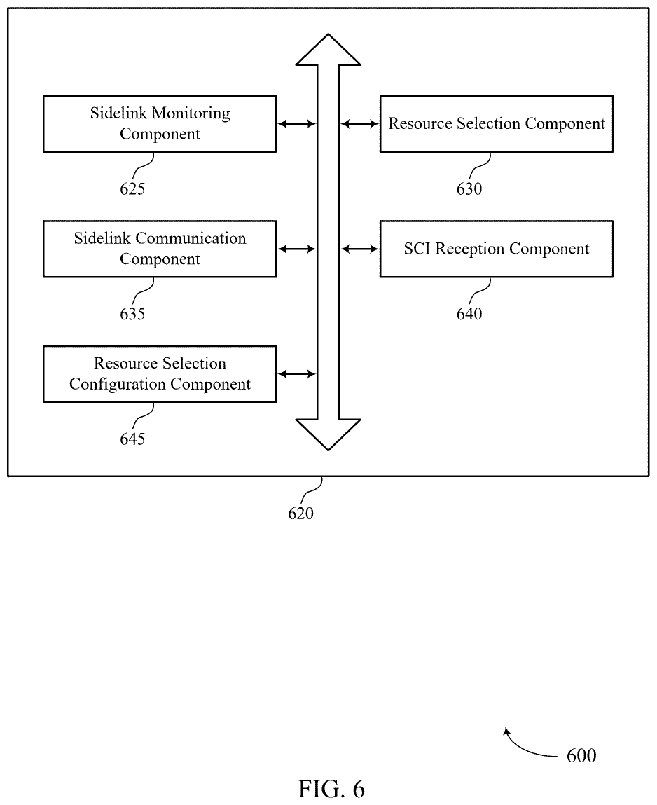

FIG. 6 shows a block diagram 600 of a communications manager 620 that supports sidelink resource selection for aircraft communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of sidelink resource selection for aircraft communications as described herein. For example, the communications manager 620 may include a sidelink monitoring component 625, a resource selection component 630, a sidelink communication component 635, an SCI reception component 640, a resource selection configuration component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The sidelink monitoring component 625 is capable of, configured to, or operable to support a means for monitoring at least a first set of sidelink shared channel resources in a radio frequency spectrum band associated with aircraft communications. The resource selection component 630 is capable of, configured to, or operable to support a means for selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The sidelink communication component 635 is capable of, configured to, or operable to support a means for performing the sidelink communications via at least a portion of the second set of sidelink shared channel resources.

In some examples, the SCI reception component 640 is capable of, configured to, or operable to support a means for receiving, via a sidelink control channel resource, sidelink control information from a transmitting device that indicates whether a transmission in a sidelink shared channel resource of the first set of sidelink shared channel resources is associated with an additional maximum power reduction.

In some examples, the sidelink control information indicates a value for the additional maximum power reduction.

In some examples, the selection of one or more sidelink shared channel resources of the second set of sidelink shared channel resources is based on the one or more sidelink shared channel resources being associated with a corresponding set of one or more smallest additional maximum power reductions.

In some examples, the selection of one or more sidelink shared channel resources of the second set of sidelink shared channel resources is based on a corresponding one or more additional maximum power reductions associated with the one or more sidelink shared channel resources and a corresponding one or more reference signal strength indicator values associated with the one or more sidelink shared channel resources.

In some examples, the selection of one or more sidelink shared channel resources of the second set of sidelink shared channel resources is based on a corresponding one or more additional maximum power reductions associated with the one or more sidelink shared channel resources satisfying an additional maximum power reduction threshold.

In some examples, the selection of one or more sidelink shared channel resources of the second set of sidelink shared channel resources is based on applying an offset scaling factor to a corresponding one or more additional maximum power reductions associated with the one or more sidelink shared channel resources.

In some examples, the signal power threshold is based on a first threshold and values of the additional maximum power reductions for sidelink shared channel resources associated with additional maximum power reduction.

In some examples, the signal power threshold is based on a difference between a first threshold associated with the radio frequency spectrum band and a second threshold associated with the first set of sidelink shared channel resources.

In some examples, based on the additional maximum power reductions satisfying an additional maximum power reductions threshold, the signal power threshold is based on the additional maximum power reductions.

In some examples, the signal power threshold is based on an offset scaling factor to the additional maximum power reductions.

In some examples, a threshold quantity of sidelink shared channel resources included in the second set of sidelink shared channel resources is based on a type of the wireless device, configuration information for additional maximum power reduction, a service type of the sidelink communications, a traffic type of the sidelink communications, the radio frequency spectrum band, or any combination thereof.

In some examples, the resource selection configuration component 645 is capable of, configured to, or operable to support a means for receiving configuration information that indicates a threshold quantity of sidelink shared channel resources in the second set of sidelink shared channel resources.

In some examples, the resource selection component 630 is capable of, configured to, or operable to support a means for reporting the second set of sidelink shared channel resources to a higher layer of the wireless device based on selecting the second set of sidelink shared channel resources.

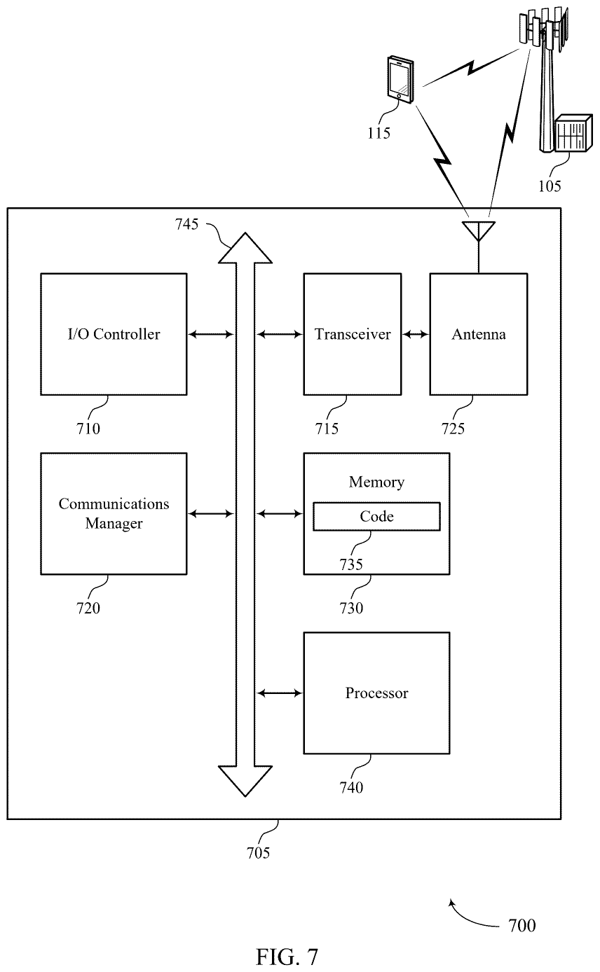

FIG. 7 shows a diagram of a system 700 including a device 705 that supports sidelink resource selection for aircraft communications in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting sidelink resource selection for aircraft communications). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for monitoring at least a first set of sidelink shared channel resources in a radio frequency spectrum band associated with aircraft communications. The communications manager 720 is capable of, configured to, or operable to support a means for selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The communications manager 720 is capable of, configured to, or operable to support a means for performing the sidelink communications via at least a portion of the second set of sidelink shared channel resources.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of sidelink resource selection for aircraft communications as described herein, or the at least one processor 740 and the at least one memory 730 may be otherwise configured to, individually or collectively, perform or support such operations.

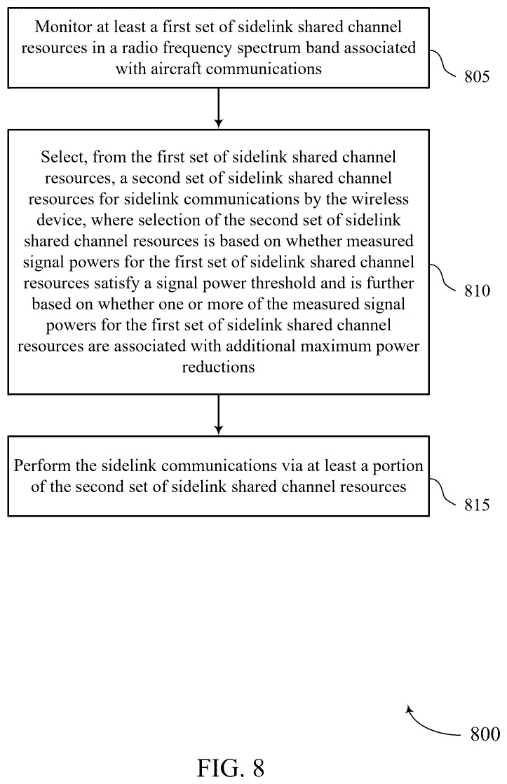

FIG. 8 shows a flowchart illustrating a method 800 that supports sidelink resource selection for aircraft communications in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include monitoring at least a first set of sidelink shared channel resources in a radio frequency spectrum band associated with aircraft communications. The operations of 805 may be performed in accordance with examples as disclosed herein. In some examples, aspects of the operations of 805 may be performed by a sidelink monitoring component 625 as described with reference to FIG. 6.

At 810, the method may include selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The operations of 810 may be performed in accordance with examples as disclosed herein. In some examples, aspects of the operations of 810 may be performed by a resource selection component 630 as described with reference to FIG. 6.

At 815, the method may include performing the sidelink communications via at least a portion of the second set of sidelink shared channel resources. The operations of 815 may be performed in accordance with examples as disclosed herein. In some examples, aspects of the operations of 815 may be performed by a sidelink communication component 635 as described with reference to FIG. 6.

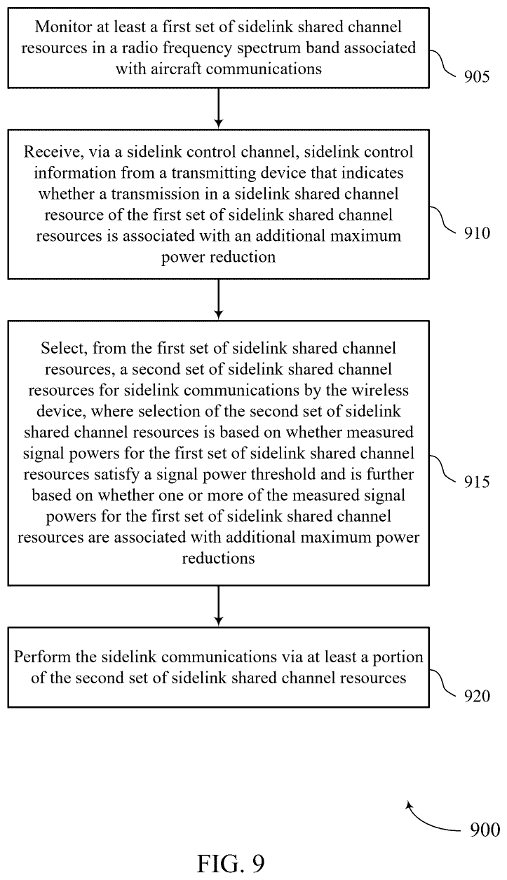

FIG. 9 shows a flowchart illustrating a method 900 that supports sidelink resource selection for aircraft communications in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include monitoring at least a first set of sidelink shared channel resources in a radio frequency spectrum band associated with aircraft communications. The operations of 905 may be performed in accordance with examples as disclosed herein. In some examples, aspects of the operations of 905 may be performed by a sidelink monitoring component 625 as described with reference to FIG. 6.

At 910, the method may include receiving, via a sidelink control channel resource, sidelink control information from a transmitting device that indicates whether a transmission in a sidelink shared channel resource of the first set of sidelink shared channel resources is associated with an additional maximum power reduction. The operations of 910 may be performed in accordance with examples as disclosed herein. In some examples, aspects of the operations of 910 may be performed by an SCI reception component 640 as described with reference to FIG. 6.

At 915, the method may include selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The operations of 915 may be performed in accordance with examples as disclosed herein. In some examples, aspects of the operations of 915 may be performed by a resource selection component 630 as described with reference to FIG. 6.

At 920, the method may include performing the sidelink communications via at least a portion of the second set of sidelink shared channel resources. The operations of 920 may be performed in accordance with examples as disclosed herein. In some examples, aspects of the operations of 920 may be performed by a sidelink communication component 635 as described with reference to FIG. 6.

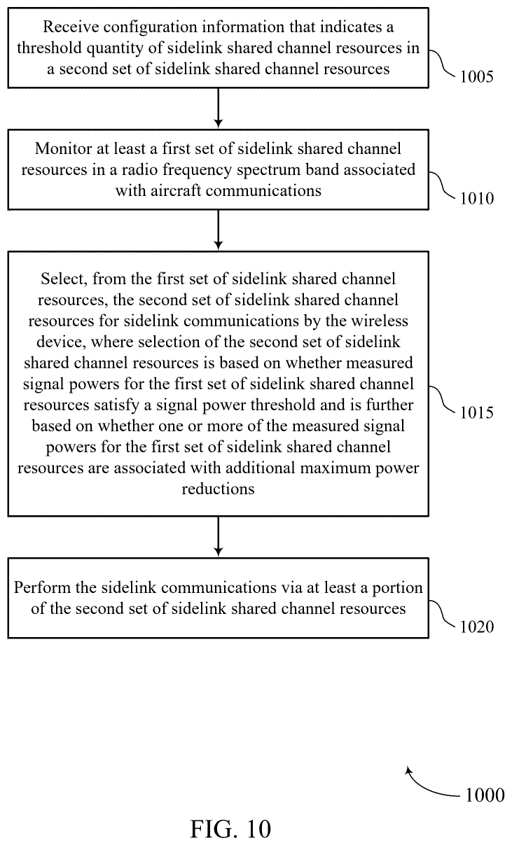

FIG. 10 shows a flowchart illustrating a method 1000 that supports sidelink resource selection for aircraft communications in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving configuration information that indicates a threshold quantity of sidelink shared channel resources in the second set of sidelink shared channel resources. The operations of 1005 may be performed in accordance with examples as disclosed herein. In some examples, aspects of the operations of 1005 may be performed by a resource selection configuration component 645 as described with reference to FIG. 6.

At 1010, the method may include monitoring at least a first set of sidelink shared channel resources in a radio frequency spectrum band associated with aircraft communications. The operations of 1010 may be performed in accordance with examples as disclosed herein. In some examples, aspects of the operations of 1010 may be performed by a sidelink monitoring component 625 as described with reference to FIG. 6.

At 1015, the method may include selecting, from the first set of sidelink shared channel resources, a second set of sidelink shared channel resources for sidelink communications by the wireless device, where selection of the second set of sidelink shared channel resources is based on whether measured signal powers for the first set of sidelink shared channel resources satisfy a signal power threshold and is further based on whether one or more of the measured signal powers for the first set of sidelink shared channel resources are associated with additional maximum power reductions. The operations of 1015 may be performed in accordance with examples as disclosed herein. In some examples, aspects of the operations of 1015 may be performed by a resource selection component 630 as described with reference to FIG. 6.

At 1020, the method may include performing the sidelink communications via at least a portion of the second set of sidelink shared channel resources. The operations of 1020 may be performed in accordance with examples as disclosed herein. In some examples, aspects of the operations of 1020 may be performed by a sidelink communication component 635 as described with reference to FIG. 6.

The following provides an overview of aspects of the present disclosure:
Aspect 1: A method for wireless communications at a wireless device, comprising: monitoring at least a first set of sidelink shared channel resources in a radio frequency spectrum band associated with aircraft communications; selecting, from the first set of sidelink shared channel resources, a second set of sidelink shared channel resources for sidelink communications by the wireless device, wherein selection of the second set of sidelink shared channel resources is based at least in part on whether measured signal powers for the first set of sidelink shared channel resources satisfy a signal power threshold and is further based at least in part on whether one or more of the measured signal powers for the first set of sidelink shared channel resources are associated with additional maximum power reductions; and performing the sidelink communications via at least a portion of the second set of sidelink shared channel resources.
Aspect 2: The method of aspect 1, further comprising: receiving, via a sidelink control channel resource, sidelink control information from a transmitting device that indicates whether a transmission in a sidelink shared channel resource of the first set of sidelink shared channel resources is associated with an additional maximum power reduction.
Aspect 3: The method of aspect 2, wherein the sidelink control information indicates a value for the additional maximum power reduction.
Aspect 4: The method of any of aspects 1 through 3, wherein the selection of one or more sidelink shared channel resources of the second set of sidelink shared channel resources is based at least in part on the one or more sidelink shared channel resources being associated with a corresponding set of one or more smallest additional maximum power reductions.
Aspect 5: The method of any of aspects 1 through 4, wherein the selection of one or more sidelink shared channel resources of the second set of sidelink shared channel resources is based at least in part on a corresponding one or more additional maximum power reductions associated with the one or more sidelink shared channel resources and a corresponding one or more reference signal strength indicator values associated with the one or more sidelink shared channel resources.
Aspect 6: The method of any of aspects 1 through 5, wherein the selection of one or more sidelink shared channel resources of the second set of sidelink shared channel resources is based at least in part on a corresponding one or more additional maximum power reductions associated with the one or more sidelink shared channel resources satisfying an additional maximum power reduction threshold.
Aspect 7: The method of any of aspects 1 through 6, wherein the selection of one or more sidelink shared channel resources of the second set of sidelink shared channel resources is based at least in part on applying an offset scaling factor to a corresponding one or more additional maximum power reductions associated with the one or more sidelink shared channel resources.
Aspect 8: The method of any of aspects 1 through 7, wherein the signal power threshold is based at least in part on a first threshold and values of the additional maximum power reductions for sidelink shared channel resources associated with additional maximum power reduction.
Aspect 9: The method of any of aspects 1 through 8, wherein the signal power threshold is based at least in part on a difference between a first threshold associated with the radio frequency spectrum band and a second threshold associated with the first set of sidelink shared channel resources.
Aspect 10: The method of any of aspects 1 through 9, wherein the signal power threshold is based at least in part on the additional maximum power reductions based at least in part on the additional maximum power reductions satisfying additional maximum power reductions thresholds.
Aspect 11: The method of any of aspects 1 through 10, wherein the signal power threshold is based at least in part on an offset scaling factor to the additional maximum power reductions.
Aspect 12: The method of any of aspects 1 through 11, wherein a threshold quantity of sidelink shared channel resources included in the second set of sidelink shared channel resources is based at least in part on a type of the wireless device, configuration information for additional maximum power reduction, a service type of the sidelink communications, a traffic type of the sidelink communications, the radio frequency spectrum band, or any combination thereof.
Aspect 13: The method of any of aspects 1 through 12, further comprising: receiving configuration information that indicates a threshold quantity of sidelink shared channel resources in the second set of sidelink shared channel resources.

Aspect 14: The method of any of aspects 1 through 13, further comprising: reporting the second set of sidelink shared channel resources to a higher layer of the wireless device based at least in part on selecting the second set of sidelink shared channel resources.

Aspect 15: A wireless device for wireless communications, comprising one or more memories storing processor-executable code, and one or more processors coupled with the one or more memories and individually or collectively operable to execute the code to cause the wireless device to perform a method of any of aspects 1 through 14.

Aspect 16: A wireless device for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “set” shall be construed as including the possibility of a set with one member. Thus, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a wireless device, comprising:
one or more processors; and
instructions stored in one or more memories and executable by the one or more processors, individually or collectively, to cause the apparatus to:
monitor at least a first set of sidelink shared channel resources in a radio frequency spectrum band associated with aircraft communications;
select, from the first set of sidelink shared channel resources, a second set of sidelink shared channel resources for sidelink communications by the wireless device, wherein selection of the second set of sidelink shared channel resources is based at least in part on whether measured signal powers for the first set of sidelink shared channel resources satisfy a signal power threshold and is further based at least in part on whether one or more of the measured signal powers for the first set of sidelink shared channel resources are associated with additional maximum power reductions; and
perform the sidelink communications via at least a portion of the second set of sidelink shared channel resources.

2. The apparatus of claim 1, wherein the instructions are further executable by the one or more processors, individually or collectively, to cause the wireless device to:
receive, via a sidelink control channel resource, sidelink control information from a transmitting device that indicates whether a transmission in a sidelink shared channel resource of the first set of sidelink shared channel resources is associated with an additional maximum power reduction.

3. The apparatus of claim 2, wherein the sidelink control information indicates a value for the additional maximum power reduction.

4. The apparatus of claim 1, wherein the selection of one or more sidelink shared channel resources of the second set of sidelink shared channel resources is based at least in part on the one or more sidelink shared channel resources being associated with a corresponding set of one or more smallest additional maximum power reductions.

5. The apparatus of claim 1, wherein the selection of one or more sidelink shared channel resources of the second set of sidelink shared channel resources is based at least in part on a corresponding one or more additional maximum power reductions associated with the one or more sidelink shared channel resources and a corresponding one or more reference signal strength indicator values associated with the one or more sidelink shared channel resources.

6. The apparatus of claim 1, wherein the selection of one or more sidelink shared channel resources of the second set of sidelink shared channel resources is based at least in part on a corresponding one or more additional maximum power reductions associated with the one or more sidelink shared channel resources satisfying an additional maximum power reduction threshold.

7. The apparatus of claim 1, wherein the selection of one or more sidelink shared channel resources of the second set of sidelink shared channel resources is based at least in part on application of an offset scaling factor to a corresponding one or more additional maximum power reductions associated with the one or more sidelink shared channel resources.

8. The apparatus of claim 1, wherein the signal power threshold is based at least in part on a first threshold and values of the additional maximum power reductions for sidelink shared channel resources associated with additional maximum power reduction.

9. The apparatus of claim 1, wherein the signal power threshold is based at least in part on a difference between a first threshold associated with the radio frequency spectrum band and a second threshold associated with the first set of sidelink shared channel resources.

10. The apparatus of claim 1, wherein, based at least in part on the additional maximum power reductions satisfying an additional maximum power reduction threshold, the signal power threshold is based at least in part on the additional maximum power reductions.

11. The apparatus of claim 1, wherein the signal power threshold is based at least in part on an offset scaling factor to the additional maximum power reductions.

12. The apparatus of claim 1, wherein a threshold quantity of sidelink shared channel resources included in the second set of sidelink shared channel resources is based at least in part on a type of the wireless device, configuration information for additional maximum power reduction, a service type of the sidelink communications, a traffic type of the sidelink communications, the radio frequency spectrum band, or any combination thereof.

13. The apparatus of claim 1, wherein the instructions are further executable by the one or more processors, individually or collectively, to cause the wireless device to:
receive configuration information that indicates a threshold quantity of sidelink shared channel resources in the second set of sidelink shared channel resources.

14. A method for wireless communications at a wireless device, comprising:
monitoring at least a first set of sidelink shared channel resources in a radio frequency spectrum band associated with aircraft communications;
selecting, from the first set of sidelink shared channel resources, a second set of sidelink shared channel resources for sidelink communications by the wireless device, wherein selection of the second set of sidelink shared channel resources is based at least in part on whether measured signal powers for the first set of sidelink shared channel resources satisfy a signal power threshold and is further based at least in part on whether one or more of the measured signal powers for the first set of sidelink shared channel resources are associated with additional maximum power reductions; and
performing the sidelink communications via at least a portion of the second set of sidelink shared channel resources.

15. The method of claim 14, further comprising:
receiving, via a sidelink control channel resource, sidelink control information from a transmitting device that indicates whether a transmission in a sidelink shared channel resource of the first set of sidelink shared channel resources is associated with an additional maximum power reduction.

16. The method of claim 15, wherein the sidelink control information indicates a value for the additional maximum power reduction.

17. The method of claim 14, wherein the selection of one or more sidelink shared channel resources of the second set of sidelink shared channel resources is based at least in part on the one or more sidelink shared channel resources being associated with a corresponding set of one or more smallest additional maximum power reductions.

18. The method of claim 14, wherein the selection of one or more sidelink shared channel resources of the second set of sidelink shared channel resources is based at least in part on a corresponding one or more additional maximum power reductions associated with the one or more sidelink shared channel resources and a corresponding one or more reference signal strength indicator values associated with the one or more sidelink shared channel resources.

19. The method of claim 14, wherein the selection of one or more sidelink shared channel resources of the second set of sidelink shared channel resources is based at least in part on a corresponding one or more additional maximum power reductions associated with the one or more sidelink shared channel resources satisfying an additional maximum power reduction threshold.

20. A non-transitory computer-readable medium storing code for wireless communications at a wireless device, the code comprising instructions executable by one or more processors to:
monitor at least a first set of sidelink shared channel resources in a radio frequency spectrum band associated with aircraft communications;
select, from the first set of sidelink shared channel resources, a second set of sidelink shared channel resources for sidelink communications by the wireless device, wherein selection of the second set of sidelink shared channel resources is based at least in part on whether measured signal powers for the first set of sidelink shared channel resources satisfy a signal power threshold and is further based at least in part on whether one or more of the measured signal powers for the first set of sidelink shared channel resources are associated with additional maximum power reductions; and
perform the sidelink communications via at least a portion of the second set of sidelink shared channel resources.
